(19) United States
(12) Patent Application Publication
(10) Pub. No.: US 2006/0096344 A1
(43) Pub. Date: May 11, 2006

(54) Cylinder lock

(75) Inventor: Miko Lee, Hsin Chuang City (TW)

Correspondence Address: BACON & THOMAS, PLLC, 625 SLATERS LANE, FOURTH FLOOR, ALEXANDRIA, VA, 22314, US

(73) Assignee: Grace Lin, Taipei Hsien (TW)

(21) Appl. No.: 11/172,833

(22) Filed: Jul. 5, 2005

(30) Foreign Application Priority Data
Nov. 5, 2004 (TW) 093133722

(51) Int. Cl. E05B 27/08

(52) U.S. Cl. 70/491

(57) ABSTRACT

A cylinder lock includes a locking core rotatably received in a lock housing. A first disk is integrally formed outside the locking core, and a second disk is rotatably provided on the locking core. A channel is longitudinally defined at a center of the locking core, and a shaft with stepped slots is movably received in the channel. A latching member is radially received in the first disk, and has a spherical head partially positioned in the lock housing, and a shank extending in the stepped slots. A correct key has a finger for pushing the shaft inwards, so the latching member can be released from the lock housing to enable the locking core to turn about the lock housing. Whereby, the cylinder core has a high level of security.

### BACKGROUND OF THE INVENTION

1. Field of the Invention

The present invention relates to a cylinder lock, and more particularly to a cylinder lock with a high level of security.

2. Description of Related Art

With reference to FIGS. 13 and 14, a conventional cylinder lock has a lock housing (70). A turnable locking core (71) is received in the lock housing (70). A first disk (72) is integrally formed outside the locking core (71), and multiple first holes (721) are longitudinally defined in the first disk (72) and around the locking core (71). A second disk (73) is rotatably provided outside the locking core (71) and received in the housing (70). Multiple second holes (731) are longitudinally defined in the second disk (73) and respectively aligned with the first holes (721). Multiple first pins (722) are respectively received in the first holes (721), and multiple second pins (732) are respectively received in the second holes (731). Multiple resilient members (733) are respectively received in the second holes (731) to push the second pins (732) and first pins (722) towards the first disk (72). In this case, the second pins (732) are located between the first disk (72) and second disk (73), so the locking core (71) can not be turned and the cylinder lock is in a locked status.

When a correct key (80) with slots (81) is inserted in the cylinder lock, the first pins (722) are pushed inwards various distances by means of the slots (81) corresponding to the first holes (721), and contact faces between the first pins (722) and second pins (732) are just in coincidence with an interface between the first disk (72) and second disk (73). Then, the locking core (71) can be turned by the key (80), and the cylinder lock is in an unlocked status.

The cylinder lock can be unlocked only when the slots (81) have correct lengths to correspond to those of the first and second pins (721, 732). However, a thief may use some tools such as a plastic pen barrel (90) to unlock the cylinder lock. The thief can insert the plastic pen barrel (90) into the first hole to push the first pins (722). After trying this for a few times, the plastic pen barrel (90) will be defined with notches (91) equivalent to the respective slots (81), so the lock (70) can be unlocked. Therefore, the conventional cylinder lock has a low level of security.

Therefore, the invention provides a cylinder lock to mitigate or obviate the aforementioned problems.

### SUMMARY OF THE INVENTION

The main objective of the present invention is to provide a cylinder lock with a high level of security and a key to match the cylinder lock.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a cylinder lock in accordance with the present invention;

FIG. 2 is a perspective sectional view of the cylinder lock;

FIG. 3 is a cross sectional view of the cylinder lock and a key to match the cylinder lock;

FIG. 4 is a cross sectional view of the key inserted in the cylinder lock;

FIG. 5 is a side sectional view of the cylinder lock when a correct key is inserted in the cylinder lock;

FIG. 6 is a side sectional view of the cylinder lock when the correct key is turned to unlock the lock;

FIG. 7 is a cross sectional view of the cylinder lock inserted with plastic tools;

FIG. 8 is a perspective of another embodiment of a locking housing of the cylinder lock in accordance with the present invention;

FIG. 9 is a perspective sectional view of the cylinder lock in FIG. 8;

FIG. 10 is a cross sectional view of the key inserted in the cylinder lock in FIG. 8;

FIG. 11 is side sectional view of the cylinder lock in FIG. 8 when a correct key is inserted in the cylinder lock;

FIG. 12 is a side sectional view of the cylinder lock in FIG. 8 when the correct key is turned to unlock the lock;

FIG. 13 is a cross sectional view of a conventional cylinder lock and a matched key; and

FIG. 14 is a cross sectional view of the conventional lock being unlocked by using plastic tools.

### DETAILED DESCRIPTION OF THE PREFERRED EMBODIMENT

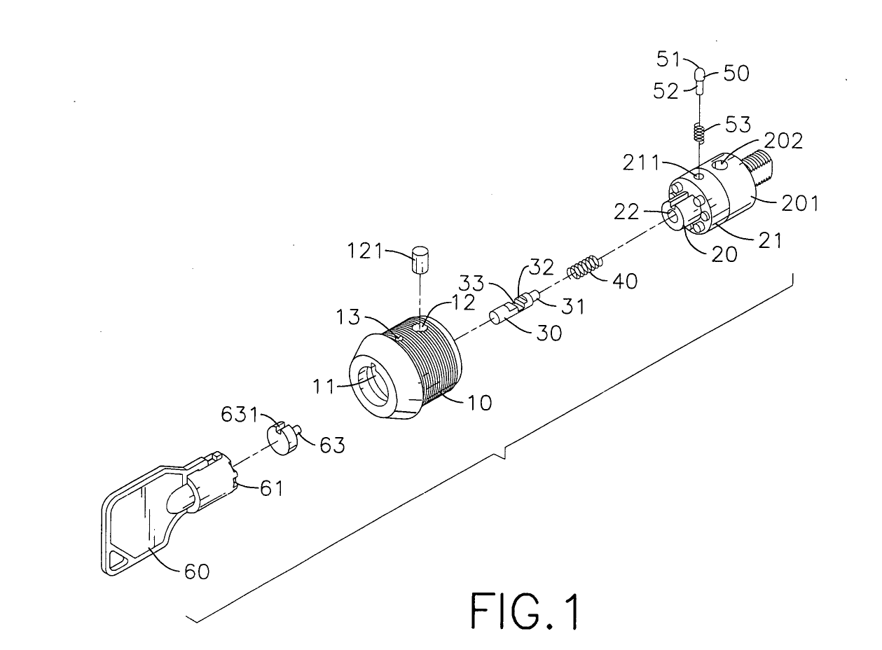

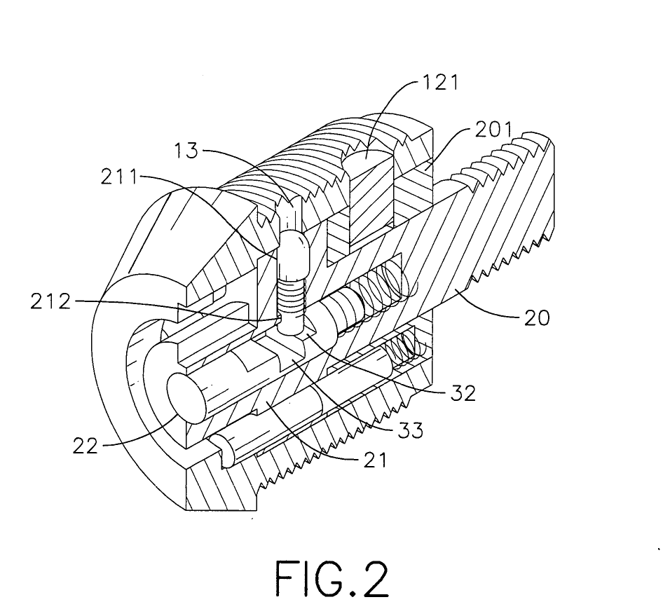

With reference to FIGS. 1-2, the cylinder lock in accordance with the present invention has a lock housing (10) with a chamber (11). The chamber (11) is defined with a plurality of segments with various diameters. A locking core (20) is received in the chamber (11) and has a structure similar to the conventional locking core.

A first disk (21) is integrally formed outside the locking core (20), and a second disk (201) is rotatably provided outside the locking core (20) and behind the first disk (21). Multiple first pins and second pins in longitudinally aligned pairs of first and second pins are received in the first disk (21) and the second disk (201) respectively. Multiple springs are received in the second disk (201) to respectively push the second pins towards the first pins.

The locking housing (10) has a positioning hole (12) and a latching hole (13) radially defined therethrough. A first orifice (211) is radially defined in an outer periphery of the first disk (21) and aligned with the latching hole (13) of which a diameter is smaller than a diameter of the first orifice (211), and a second orifice (202) is radially defined in a periphery of the second disk (201) and aligned with the positioning hole (12). An opening (212) with a diameter smaller than that of the first orifice (211) is radially defined beneath the first orifice (211). A positioning pin (121) is inserted through the positioning hole (12) and the second orifice (202) to fasten the second disk (201) in the lock housing (10).

The locking core (20) has a channel (22) longitudinally defined in a central portion thereof and in communication with the opening (212) and first orifice (211), and a shaft (30) is movably received in the channel (22) and pushed outwards by a first resilient member (40). The shaft (30) has stepped first and second slots (32, 33) defined at a middle portion thereof and facing the opening (212) and the first orifice (211), wherein the second slot (33) communicates with the first slot (32) and is deeper than the first slot (32). A stub (31) is formed at an inner end of the shaft (30) for attachment of the first resilient member (40).

With reference to FIGS. 1-3, a latching member (50) is received in the first orifice (211). The latching member (50) includes a spherical head (51) and a shank (52), wherein the spherical head (51) is received in the first orifice (211) and partially extends in the latching hole (13), and the shank (52) extends through the opening (212) and in the first slot (32) to block the shaft (30), so the shaft (30) cannot escape from the channel (22) under the force of the first resilient member (40). A second resilient member (53) is provided outside the shank (212) to push the spherical head (211) upwards, so the spherical head (211) can be retained to be partially positioned in the latching hole (13).

The configuration of the lock as mentioned above is in a locked status.

A key (60) adapted to the cylinder lock has a recess (62) defined at a front end thereof. A plug (631) is securely received in the recess (62) and a finger (63) is formed on the plug (631) and extends forwards. Multiple notches (61) are defined at the front end of the key (60) for pushing the pins of the lock.

When the key (60) is inserted in the locking core (20), the finger (63) is inserted in the channel (22) to push the shaft (30) inwards.

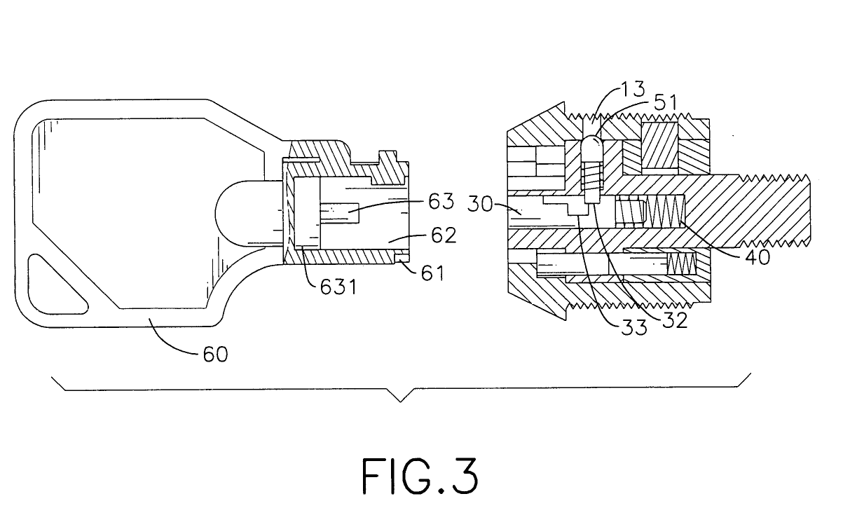

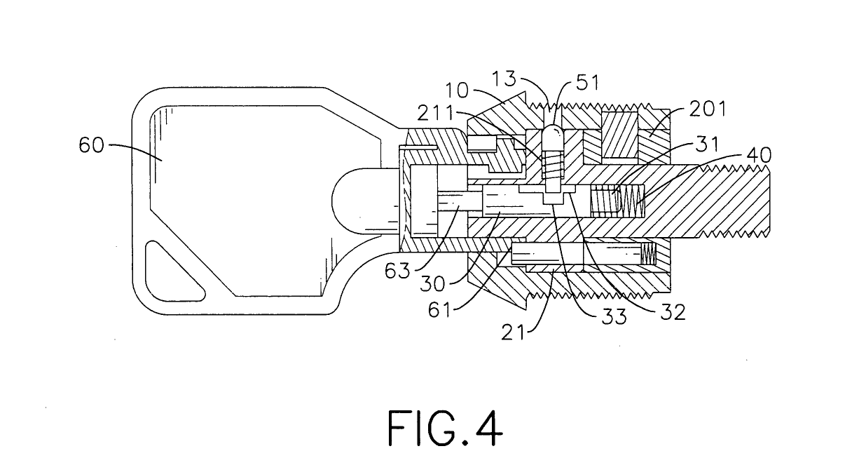

With reference to FIGS. 3 and 4, if the key (60) is correct, the pins of the lock can be correctly pushed by the front end of the key (60) to coincide the contact faces between the first pins and second pins with an interface between the first disk (21) and second disk (201). At the same time, the shaft (30) is pushed inwards to align the second slot (33) with the latching member (50), and a clearance between the shank (52) and the second slot (33) exists.

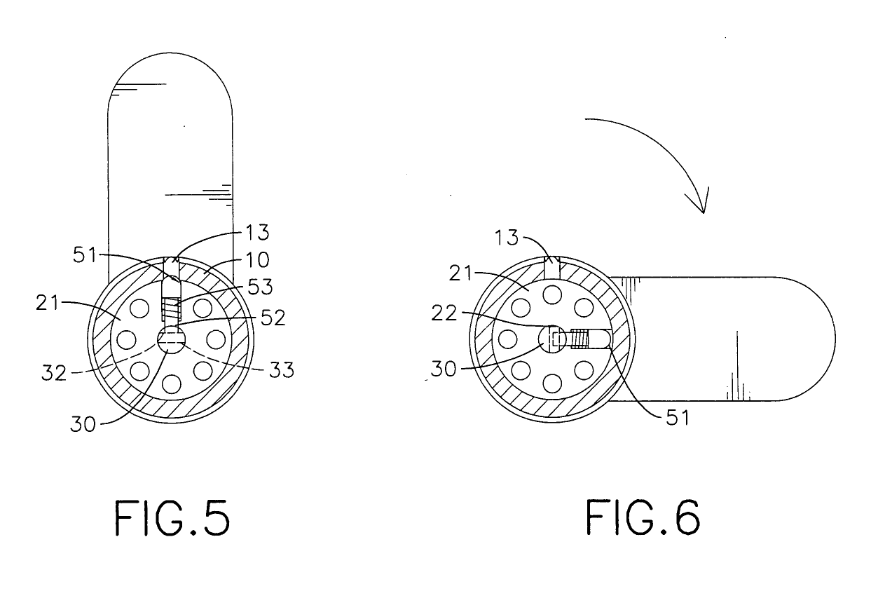

With reference to FIGS. 5 and 6, when the key (60) is turned, the spherical head (51) can be pushed by a circumferential edge of the latching hole (13) inwards and a free end of the shank (52) extends in the second slot (33) to enable the locking core (20) to turn about the lock housing (10). Then, the lock is unlocked.

Therefore, the lock is unlocked by the key (60) in a situation that not only must the notches (61) have the correct length to coincide the contact surfaces between the pins with the interface between the disks (21, 201), but also the finger (63) must have the correct length to align the second slot (33) with the shank (53). Hence, the cylinder lock has a high level of security.

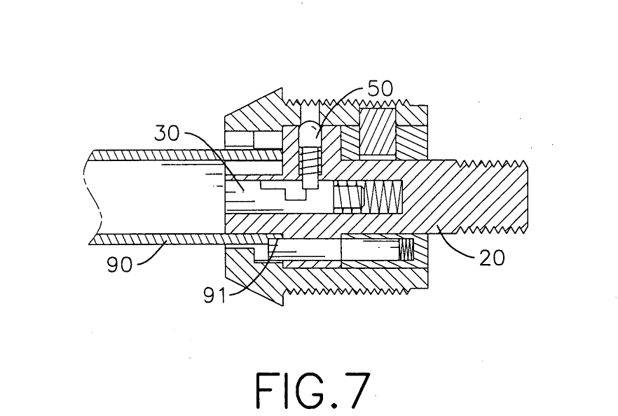

With reference to FIG. 7, when a thief tries to unlock the lock by using a pen barrel (90), because the shaft (30) is not pushed inwards to release the latching member (50), the locking core (20) still can not be turned even if all the contact surfaces between the pins coincide with the interface between the first disk (21) and second disk (201).

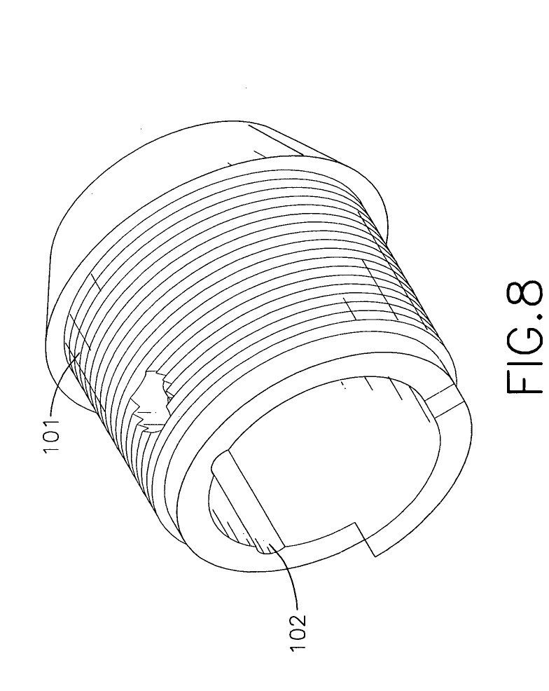

In another embodiment according to the present invention, as illustrated in FIG. 8, the cylinder lock has a lock housing (101) with at least one groove (102) for replacing the latching hole (13). In this embodiment, two grooves (102) with an included angle therebetween of 90°, i.e., a distance of ¼ circle, are longitudinally defined in an inner wall of the lock housing (101).

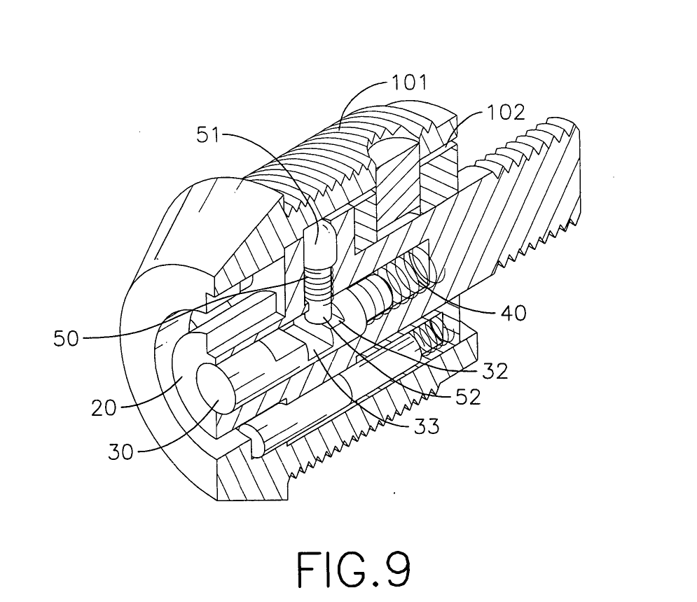

With reference to FIG. 9, the cylinder lock of this embodiment includes the same locking core (20), shaft (30), first resilient member (40), latching member (50) and key (60) as mentioned above. The spherical head (51) of the latching member (50) is positioned in one of the grooves (102), and the locking core (20) can not be turned, as illustrated in FIG. 11.

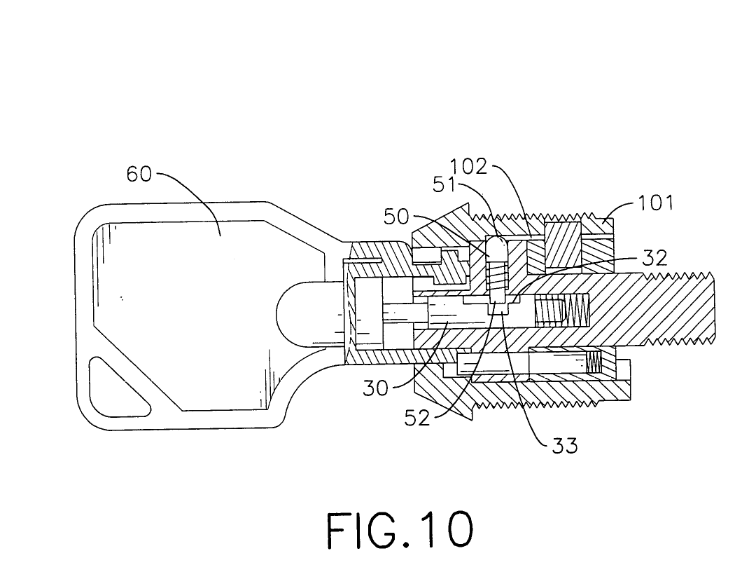

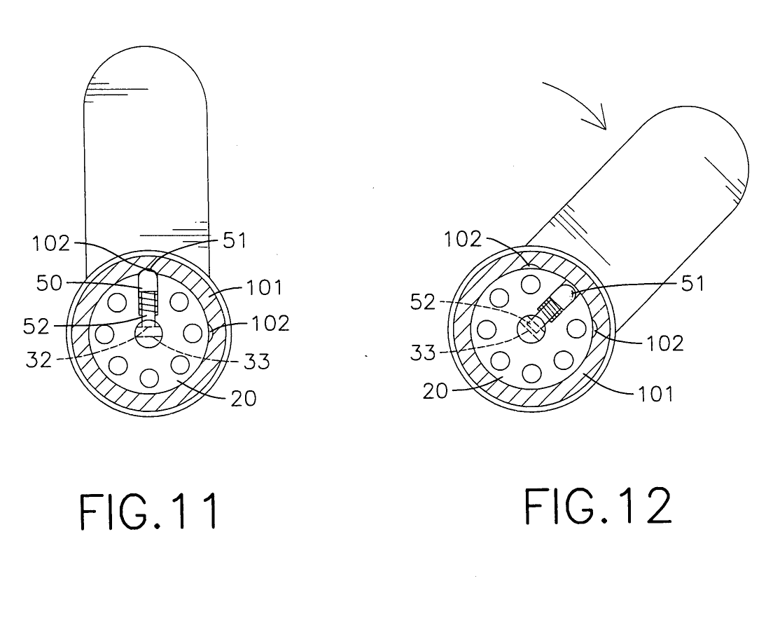

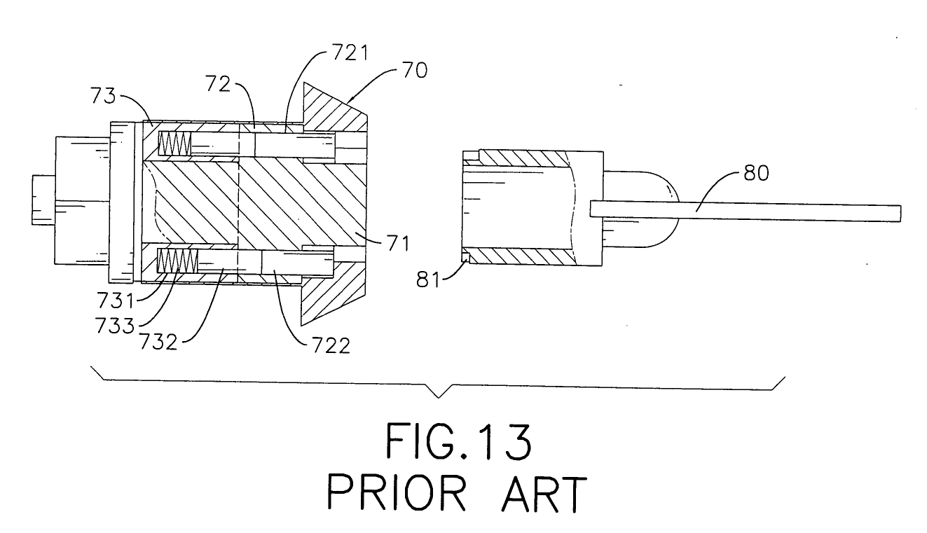

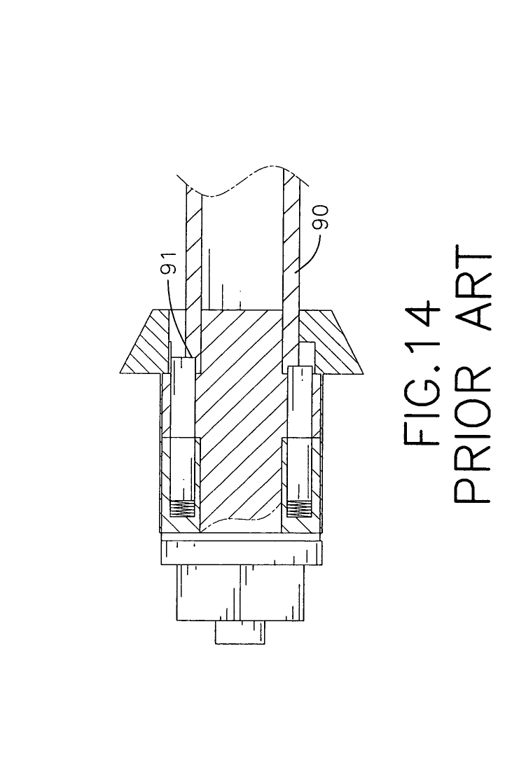

With further reference to FIGS. 10 and 12, when the correct key (60) is inserted in the locking core (20), the shaft (30) is pushed inwards to align the shank (53) with the second slot (33). Then, when the key (60) is turned, the latching member (50) can be pushed inwards and moved away from the respective groove (102), so the locking core (20) can be rotated about the lock housing (10) to unlock the cylinder lock. When the locking core (20) is turned to position the spherical head (51) in another groove (102), the key (60) can be removed from the locking core (20) and the cylinder lock can be retained in the unlocked status.

Certainly, it should be known by those skilled in the art that, in the first embodiment, the lock housing (10) can include two latching holes (13) defined therethrough for achieving the same effect as the two grooves (102).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cylinder lock comprising:
a lock housing (10) having at least one latching hole (13) defined through an outer periphery of the lock housing (10);
a locking core (20) rotatably received in the lock housing (10), the locking core (20) having a first disk (21) integrally formed outside the locking core (20), multiple first pins received in the first disk (21) and arranged around the locking core (20), a second disk (201) rotatably provided outside the locking core (20) and secured in the lock housing (10), multiple second pins received in the second disk (201) and respectively abutting the first pins, multiple springs received in the second disk (201) and respectively pushing the second pins towards the first pins, a first orifice (211) radially defined through an outer periphery of the first disk (21) and aligned with at least one latching hole (13), an opening (212) with a diameter smaller than that of the first orifice (211) and radially defined beneath the first orifice (211), a channel (22) longitudinally defined in a central portion of the locking core (20) and in communication with the first orifice (211) and opening (212);
a shaft (30) movably received in the channel (22), the shaft (30) having stepped first and second slots (32, 33) defined at a middle portion thereof and facing the opening (212), wherein the second slot (33) is deeper than and in communication with the first slot (32);
a first resilient member (40) received in the channel (22) for pushing the shaft (30) outwards; and
a latching member (50) having a spherical head (51), a shank (52), and a second resilient member (53) provided outside the shank (52), wherein the spherical head (51) is received in the first orifice (211) and partially extends in the latching hole (13), and the shank (52) extending through the opening (212) and in the first slot (32) to block the shaft (30).

2. The cylinder lock as claimed in claim 1, wherein the lock housing (10) has a positioning hole (12) radially defined through the outer periphery of the locking housing (10); the locking core (20) has a second orifice (202) defined through the outer periphery of the locking core (20) and aligned with the positioning hole (12); and a positioning pin (121) is inserted through the positioning hole (12) and the second orifice (202) to fasten the second disk (201) in the lock housing (10).

3. The cylinder lock as claimed in claim 1, wherein the shaft (30) has a stub (31) formed at an inner end of the shaft (30) for attachment with the first resilient member (40).

4. The cylinder lock as claimed in claim 1, wherein the lock housing (10) has two latching holes (13) defined through the outer periphery of the lock housing with an included angle therebetween of 90°.

5. A cylinder lock comprising:
a lock housing (10) having at least one groove (102) longitudinally defined at an inner wall of the lock housing (10);
a locking core (20) rotatably received in the lock housing (10), the locking core (20) having a first disk (21) integrally formed outside the locking core (20), multiple first pins received in the first disk (21) and arranged around the locking core (20), a second disk (201) rotatably provided outside the locking core (20) and secured in the lock housing (10), multiple second pins received in the second disk (201) and respectively abutting the first pins, multiple springs received in the second disk (201) and respectively pushing the second pins towards the first pins, a first orifice (211) radially defined through an outer periphery of the first disk (21) and in communication with the at least one groove (102), an opening (212) with a diameter smaller than that of the first orifice (211) and radially defined beneath the first orifice (211), a channel (22) longitudinally defined in a central portion of the locking core (20) and in communication with the first orifice (211) and opening (212);
a shaft (30) movably received in the channel (22), the shaft (30) having stepped first and second slots (32, 33) defined at a middle portion thereof and facing the opening (212), wherein the second slot (33) is deeper than and in communication with the first slot (32);
a first resilient member (40) received in the channel (22) for pushing the shaft (30) outwards; and
a latching member (50) having a spherical head (51), a shank (52), and a second resilient member (53) provided outside the shank (52), wherein the spherical head (51) is received in the first orifice (211) and partially extends in the groove (102), and the shank (52) extending through the opening (212) and in the first slot (32) to block the shaft (30).

6. The cylinder lock as claimed in claim 5, wherein the lock housing (10) has a positioning hole (12) radially defined through the outer periphery of the locking housing (10); the locking core (20) has a second orifice (202) defined through the outer periphery of the locking core (20) and aligned with the positioning hole (12); and a positioning pin (121) is inserted through the positioning hole (12) and the second orifice (202) to fasten the second disk (201) in the lock housing (10).

7. The cylinder lock as claimed in claim 5, wherein the shaft (30) has a stub (31) formed at an inner end of the shaft (30) for attachment with the first resilient member (40).

8. The cylinder lock as claimed in claim 5, wherein the lock housing (10) has two grooves (102) defined at the inner wall of the lock housing (10) with an included angle therebetween of 90°.

9. A key adapted to a cylinder lock comprising:
a front end;
a recess (62) defined in the front end;
multiple notches (61) defined around the recess (62); and
a finger (631) formed in the recess (62) and extending forwards to the front end.

10. The key as claimed in claim 9 further comprising a plug (631) securely provided in the recess (62), and the finger (631) formed on the plug (631).
